(19) United States
(12) Patent Application Publication
(10) Pub. No.: US 2026/0134055 A1
(43) Pub. Date: May 14, 2026

(54) QUANTIZED WINOGRAD CONVOLUTION

(71) Applicant: Arm Limited, Cambridge (GB)

(72) Inventors: Shuokai PAN, Weald (GB); Gerti TUZI, Austin, TX (US); Dibakar GOPE, Austin, TX (US)

(21) Appl. No.: 18/989,496

(22) Filed: Dec. 20, 2024

Related U.S. Application Data
(60) Provisional application No. 63/720,451, filed on Nov. 14, 2024.

(51) Int. Cl. G06F 17/15; G06N 3/0464; G06N 3/08

(52) U.S. Cl. CPC G06F 17/153; G06N 3/0464; G06N 3/08

(57) ABSTRACT

A method is described for processing a neural network. The method comprises generating a Winograd neural network by applying a Winograd convolution to at least a portion of one or more layers of the neural network and quantizing at least one operation in the Winograd convolution. The Winograd neural network is trained with at least two of a weight scale matrix, a data scale matrix, and an output scale matrix as trainable parameters by comparing an output of the neural network and an output of the Winograd neural network and adjusting the trainable parameters to generate a trained Winograd neural network. The method generates data, such as trained scale matrices, to process the trained Winograd neural network on a processing unit.

### CROSS-REFERENCE TO RELATED APPLICATIONS

This application claims the benefit of U.S. provisional patent application No. 63/720,451, filed on Nov. 14, 2024, the entire content of which is incorporated herein by reference.

### BACKGROUND OF THE INVENTION

### Field of the Invention

The present invention relates to a method, performed by an information processing apparatus, of generating data to be processed on a processing unit, a non-transitory computer-readable storage medium, and an information processing apparatus.

### Description of the Related Technology

In recent years, foundation diffusion models have risen in popularity in the field of image generation due to their ability to produce complex and detailed high-quality photorealistic images from natural language prompts. Furthermore, foundation diffusion models have demonstrated their flexibility in supporting and achieving high-quality performance on a wide range of downstream computer vision tasks, such as image editing, style transformation, image super-resolution (upscaling), image-to-image translation, and many other tasks. In contrast previous Generative Adversarial Networks (GANs)-based image generation models had been difficult to use for such tasks because they tended to be unstable to train.

However, diffusion models typically require many denoising steps and forward passes to convert Gaussian noise into real images, in some cases using neural network layers with over 1 billion parameters. Therefore, deploying these large-scale diffusion models on-device for inference has been a significant challenge due to their unprecedented size, memory bandwidth, and compute cost requirements.

Quantization has proven to be an effective method for converting high-precision (such as 16 or 32-bit) model weights and activations to lower-precision values, such as 8-bit integers, reducing a model's memory and computational requirements while maintaining accuracy. Among different quantization methods, data-free post-training quantization (PTQ) compresses model parameters after training. While previous attempts have been made to quantize weights and activations in diffusion models using coarse-grained PTQ techniques, such as tensor-wise or channel-wise quantization, these attempts often resulted in tangible loss of quality, especially under low-bit settings. One issue with these coarser-grained quantization approaches is that outlier values, can have a disproportionate impact on scaling. Consequently, the full range of the lower-precision data type is not used effectively, which lowers the quantized model's accuracy.

Accordingly, there is a need for improved techniques for preserving image generation quality when quantizing large scale models, such as large-scale diffusion models.

### SUMMARY

According to a first aspect there is provided a method, performed by an information processing apparatus, of generating data to be processed on a processing unit, the method comprising: obtaining a neural network; generating a Winograd neural network by applying a Winograd convolution to at least a portion of one or more layers of the neural network and quantizing at least one operation in the Winograd convolution, wherein the Winograd convolution can be expressed using a weight transformation matrix, a data transformation matrix, and an output transformation matrix, wherein the weight transformation matrix is a product of a weight scale matrix and a first Vandemonde matrix, the data transformation matrix is a product of a data scale matrix and a second Vandemonde matrix, and the output transformation matrix is a product of an output scale matrix and a third Vandemonde matrix; training the Winograd neural network with at least two of the weight scale matrix, the data scale matrix, and the output scale matrix as trainable parameters by comparing an output of the neural network and an output of the Winograd neural network, and adjusting the trainable parameters to generate a trained Winograd neural network; and generating, by the information processing apparatus, data to process the trained Winograd neural network on the processing unit.

According to a second aspect there is provided a non-transitory computer-readable storage medium comprising instructions that, when executed by an information processing apparatus, cause the information processing apparatus to perform a method of generating data to be processed on a processing unit, the method comprising: obtaining a neural network; generating a Winograd neural network by applying a Winograd convolution to at least a portion of one or more layers of the neural network and quantizing at least one operation in the Winograd convolution, wherein the Winograd convolution can be expressed using a weight transformation matrix, a data transformation matrix, and an output transformation matrix, wherein the weight transformation matrix is a product of a weight scale matrix and a first Vandemonde matrix, the data transformation matrix is a product of a data scale matrix and a second Vandemonde matrix, and the output transformation matrix is a product of an output scale matrix and a third Vandemonde matrix; training the Winograd neural network with at least two of the weight scale matrix, the data scale matrix, and the output scale matrix as trainable parameters by comparing an output of the neural network and an output of the Winograd neural network, and adjusting the trainable parameters to generate a trained Winograd neural network; and generating data to process the trained Winograd neural network on the processing unit.

According to a third aspect there is provided an information processing apparatus comprising: a first processing unit; and a storage, wherein the storage stores instructions that, when executed by the information processing apparatus, causes the information processing apparatus to perform a method comprising: obtaining a neural network; generating a Winograd neural network by applying a Winograd convolution to at least a portion of one or more layers of the neural network and quantizing at least one operation in the Winograd convolution, wherein the Winograd convolution can be expressed using a weight transformation matrix, a data transformation matrix, and an output transformation matrix, wherein the weight transformation matrix is a product of a weight scale matrix and a first Vandemonde matrix, the data transformation matrix is a product of a data scale matrix and a second Vandemonde matrix, and the output transformation matrix is a product of an output scale matrix and a third Vandemonde matrix; training the Winograd neural network with at least two of the weight scale matrix, the data scale matrix, and the output scale matrix as trainable parameters by comparing an output of the neural network and an output of the Winograd neural network, and adjusting the trainable parameters to generate a trained Winograd neural network; and generating data to process the trained Winograd neural network on a second processing unit.

According to a fourth aspect there is provided a method, performed by an information processing apparatus, of performing inference using a trained Winograd neural network, wherein during inference the method comprises steps of: obtaining transformed weight values that are a product of a weight transformation matrix of the trained Winograd neural network, weights of a neural network, and a transpose of the weight transformation matrix of the trained Winograd neural network; obtaining transformed input data values that are a product of a transpose of a data transformation matrix of the trained Winograd neural network, input data values, and the data transformation matrix of the trained Winograd neural network; performing a Hadamard product of the transformed weight values and the transformed input data values to generate a matrix of intermediate values; and quantizing the intermediate values; wherein the trained Winograd neural network has been obtained by: obtaining the neural network; generating the Winograd neural network by applying a Winograd convolution to at least a portion of one or more layers of the neural network and quantizing at least one operation in the Winograd convolution, wherein the Winograd convolution can be expressed using the weight transformation matrix, the data transformation matrix, and an output transformation matrix, wherein the weight transformation matrix is a product of a weight scale matrix and a first Vandemonde matrix, the data transformation matrix is a product of a data scale matrix and a second Vandemonde matrix, and the output transformation matrix is a product of an output scale matrix and a third Vandemonde matrix; and training the Winograd neural network with at least two of the weight scale matrix, the data scale matrix, and the output scale matrix as trainable parameters by comparing an output of the neural network and an output of the Winograd neural network, and adjusting the trainable parameters to generate a trained Winograd neural network.

### BRIEF DESCRIPTION OF THE DRAWINGS

Embodiments of the invention will now be described with reference to the accompanying figures in which:

FIG. 1 is a flow diagram showing steps of a Winograd transformation;

FIG. 2 is a table showing dynamic ranges across different pixels of intermediate values in the Winograd domain (Y) in a case where scale matrices are arbitrarily selected;

FIG. 3 is a table showing dynamic ranges across different pixels of the intermediate values in the Winograd domain (Y) in a case that scale matrices are learned;

FIG. 4 is a flow diagram illustrating data-free training of scale matrices;

FIG. 5 illustrates more detail of the process for data-free training of the scale matrices;

FIG. 6 is a flow diagram illustrating calibration-input based training of scale matrices;

FIG. 7 illustrates more detail of the process for calibration-input based training of the scale matrices; and

FIG. 8 is a schematic diagram showing components of an information processing apparatus.

### DETAILED DESCRIPTION OF CERTAIN INVENTIVE EMBODIMENTS

Winograd algorithms are fast convolution algorithms based on minimal filtering theory. Winograd algorithms are known for being a fast implementation of small convolution kernels found in modern neural networks. Winograd algorithms, similar to the Fast Fourier Transform, convert tiles of input activation data and weight data into the Winograd domain, In the Winograd domain element-wise multiplications also referred to as a Hadamard product can be performed before transformation back from the Winograd domain, which reduces theoretical computation complexity for performing convolutions. In general, the larger the tile size of activation data, the greater the reduction in computational complexity, for example due to a reduction in the number of multiplications required for convolutions performed using the Winograd algorithm. However, use of a large tile size is not always preferred because larger tile sizes result in greater numerical errors due to the exponentially increasing values of the Winograd transformation matrices as tile size increases. Accordingly, Winograd algorithms are typically implemented using 32-bit floating-point arithmetic and with relatively small tile sizes, such as 4×4.

A Winograd convolution, F(m×m, r×, r), may generate an output tile, y, of size m×m with a kernel filter size of r×r.

$$y = {A}^{T} [ [ {GwG}^{T} ] ⊙ [ {B}^{T} xB ] ] A$$

or in an alternative representation:

$$W = {GwG}^{T}$$

$$X = {B}^{T} xB$$

$$Y = W ⊙ X$$

$$y = {A}^{T} YA$$

where w is a r×r filter and x is an (m+r−1)×(m+r−1) input tile. B, G, and A are called Winograd transformation matrices, where B and G transform the weights and input feature maps, respectively, from the spatial domain to the Winograd domain, and A transforms the output feature maps (Y) back to the spatial domain, after element-wise multiplication denoted by ⊙. B may be referred to as the data transformation matrix, G may be referred to as the weight transformation matrix, and A may be referred to as the output transformation matrix.

The Winograd transformation matrices can be constructed from Chinese remainder theorem by choosing n=m+r−1 pairs of so-called polynomial points or Lagrange interpolation points (f, g). The matrices can then be derived from their Vandemonde matrix, V, as shown below:

$${A}^{T} = {V}_{n x m}^{T} {S}_{A}$$

$${B}^{T} = {S}_{B} {V}_{n x m}^{- T}$$

$$G = {S}_{G} {V}_{nxr}$$

where S_{A}, S_{B}, and S_{G} are diagonal square matrices, referred to as the output scale matrix, data scale matrix, and weight scale matrix respectively, satisfying the following condition:

$${S}_{A} {S}_{B} {S}_{G} = I$$

where I is the identity matrix.

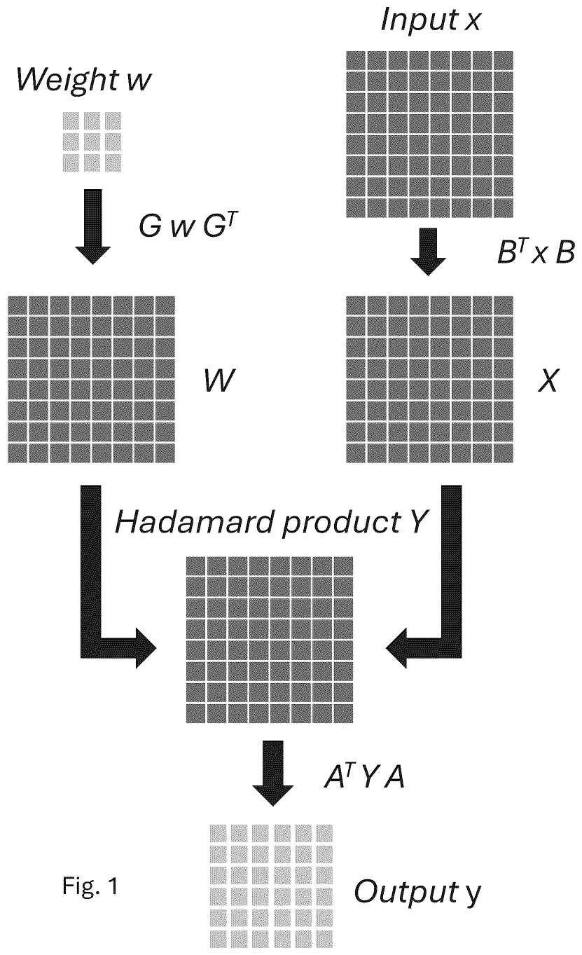

FIG. 1 is a schematic diagram illustrating the Winograd convolution. Input feature map data x is convolved with the data transformation matrix, B, as described above to generate feature map data in the Winograd domain, X. Similarly, weight data, w, is convolved with the weight transformation matrix, G, to generate weight data in the Winograd domain, W.

An element-wise multiplication, labelled Hadamard product in FIG. 1, is performed between the feature map data in the Winograd domain, X, and the weight data in the Winograd domain, W, to generate intermediate values, Y.

An output transformation from the Winograd domain is performed on the intermediate values, Y, with the output transformation matrix, A. The resulting output data is shown as Output y.

### Quantization and Challenges

Group-wise quantization is an approach to quantization of neural network model data, such as weights, biases, input data, and intermediate data, that has a finer granularity than coarser-grained quantization approaches such as tensor-wise or channel-wise quantization. When compared to coarser-grained tensor-wise or channel-wise quantization approaches, finer-grained group-wise quantization can reduce quantization noise more effectively while approaching the high-precision (floating point) quality of a model.

Group-wise quantization quantizes data in groups, such as rows or columns of a matrix, whereby weights are divided into groups, such as groups of 32, 64, or 256 data elements. Each group is then quantized individually to mitigate the effect of outliers on the quantization and increase precision.

While group-wise quantization can accelerate inference, the high computational costs of large-scale neural network models may benefit from Winograd convolution algorithm steps to meet response time requirements and pave the way for the deployment of models on edge or mobile devices. Convolution operations account for a significant proportion of the computation time in large-scale diffusion models during inference and training. While Winograd convolution computation in the quantized domain can significantly accelerate diffusion models, its use in the quantized context can result in a significant increase in quantization noise and a subsequent drop in output quality.

The use of group-wise quantization can largely resolve the quantization and associated numerical error problem of input transformation and element-wise multiplications in the Winograd domain. However, it is difficult to use group-wise quantization to quantize the intermediate values Y generated by the Hadamard product for output transformation, which accounts for a significant portion of the compute time. The quantization is difficult due to the large range differences in values. The errors in the quantization can result in a significant degradation in quality when applying group-wise quantization to Winograd convolutions.

As an example, of a group-wise quantization method, ‘INT8’ quantization computes a scale factor for each group of floating-point data values, such as a row or a column of a matrix. The data values in the group are divided by the scale factor and the floating-point data values in the group are mapped to a finite range of integers (represented in this case by 8 bits). The scale factor may be represented as a floating-point value. The resulting quantized data can be operated on efficiently using hardware designed to perform integer operations.

Examples below will focus on group-wise quantization into INT8. However, representation using INT4, where the floating-point values are mapped to 4-bit integers rather than 8-bit integers is also possible. Further, the method may be applied to reduced floating-point formats, such as a reduction from FP16 to FP8, FP4, low-precision MX FP, or non-uniform codebook-based quantization formats. Accordingly, the method is applicable to post-training quantization in which the resolution of the values being quantized is reduced.

### Learnable Winograd Transformation Scales

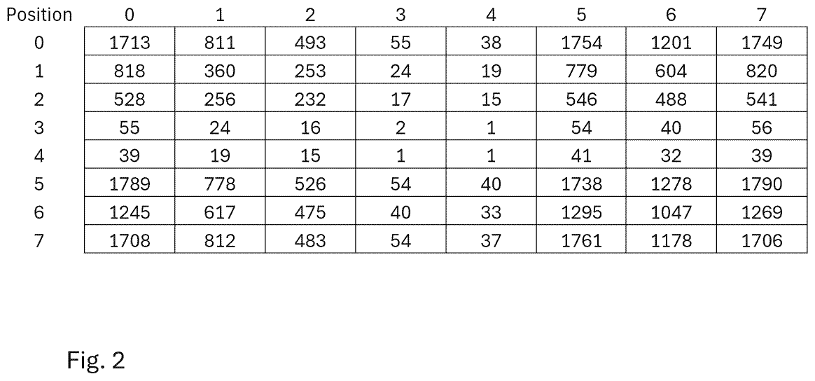

As noted above, direct application of group-wise quantization to the Winograd input transformation and Hadamard product computation generally does not have a significant impact on neural network model quality. However, this is not the case for the output transformation. This is mainly because of the huge dynamic range differences across different taps or pixels of the intermediate values, Y. To utilize efficient integer arithmetic operations in processor hardware, it would be desirable to use either a single scale factor for the entire output tile or one for each row or column. However, these approaches tend to lead to significant quantization errors due to the ‘cross’-like dynamic range differences at the 8×8 locations. FIG. 2 is a table showing dynamic ranges across different pixels of tiles of the intermediate values (Y). As indicated above, these dynamic ranges form a ‘cross’ pattern with higher dynamic ranges in the corners of the tile. The high dynamic ranges make these values difficult to quantize without imposing noticeable quantization errors.

Although pixel-wise quantization can effectively reduce this quantization error, it precludes the efficient use of integer computation circuitry in processors. Given that the intermediate values Yin the Winograd domain depend on inputs, original pre-trained weights, and the input transformation (B) and weight transformation (G) matrices, the large dynamic range of intermediate values, Y, across pixels is primarily attributed to the values of the transformation matrices B and G, as well as the variances of values in weights and inputs. In the absence of the ability to finetune original weights in the post-training quantization, which may be impossible due to lack of access to the original model data, the large range differences may be effectively reduced by manipulating the two transformation matrices, B and G, and in turn their norm of rows. As explained above, each row of the the data and weight transformation matrices B^{T} and G are scaled by the diagonal scale matrices S_{B} and S_{G}, respectively, which are directly controlling the norms of the row vectors in B^{T} and G.

Accordingly, it is possible to reduce the quantization noise of Winograd output transformation by learning the diagonal scale matrices, S_{B} and S_{G}, under the condition S_{A}=(S_{B}S_{G})⁻¹, which can be easily computed. More formally, the Vandemonde matrices are:

$${V}_{B} = {V}_{nxm}^{- T}$$

$${V}_{G} = {V}_{n x r}$$

$${V}_{A} = {V}_{n x m}^{T}$$

The Winograd transformations can be rewritten as:

$$W = {S}_{G} {V}_{{G}^{W}} {V}_{G}^{T} {S}_{G}$$

$$X = {S}_{B} {V}_{B} x {V}_{G}^{T} {S}_{G}$$

$$y = {V}_{A} {S}_{A} {YS}_{A} {V}_{A}^{T}$$

Applying group-wise quantization and integer matrix multiplication to all stages of Winograd convolution yields:

$$X \approx {s}_{q B} {s}_{q B} {s}_{q x} Q ( \frac{{S}_{B} {V}_{B}}{{s}_{q B}} ) Q ( \frac{x}{{s}_{q x}} ) Q ( \frac{{V}_{B}^{T} {S}_{B}}{{s}_{q B}} ) = \tilde{X}$$

$$Y \approx {s}_{q W} {s}_{q X} Q ( \frac{W}{{s}_{q W}} ) Q ( \frac{\tilde{X}}{{s}_{q X}} ) = \tilde{Y}$$

$$y \approx {s}_{q A} {s}_{q A} {s}_{q Y} Q ( \frac{{V}_{A} {S}_{A}}{{s}_{q A}} ) Q ( \frac{\tilde{Y}}{{s}_{q Y}} ) Q ( \frac{{S}_{A} {V}_{A}^{T}}{{s}_{q A}} ) = \tilde{y}$$

where sq* are the group-wise quantization scaling factors for the weights, activations, Hadamard product data (intermediate values), and Winograd transformation matrices and Q is a quantization function. A simple min-max is used to dynamically quantize all activations during the forward pass.

To determine the diagonal scale matrices, gradient descent (SGD) is used. The learned scale matrices, S_{G} and S_{B}, are then used to determine the group-wise quantization scale factors, sq*, as described above. For ease of setup, we treat each convolution layer independently. The scale matrices, S_{G} and S_{B}, may be learned using random Gaussian, random uniform noise, or another noise distribution. The noise distribution may include a combination of several types of random noise distributions. In some embodiments, the scale matrices could be trained separately for each convolution layer of a neural network model, such as a diffusion model. In other embodiments, rather than finetuning scale matrices separately for each convolution layer of the neural network model, a single set of scale matrices may be learnt for all layers. This further enhances the generalizability of the method.

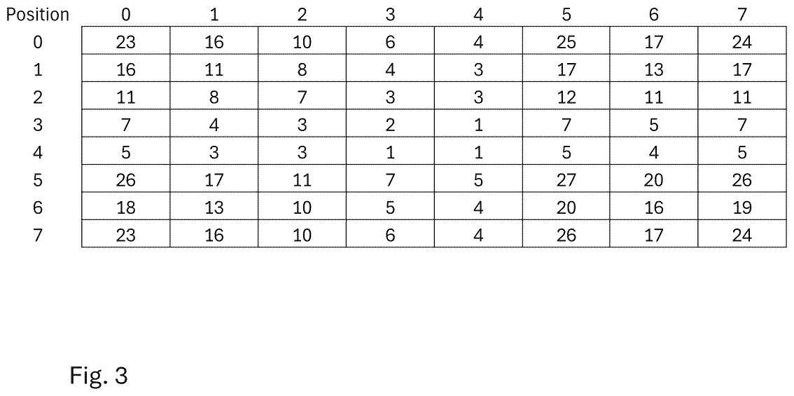

FIG. 3 is a table showing dynamic ranges across different pixels of the intermediate values (Y) for different input data, x, in a case that scales are learned. In comparison to FIG. 2, these dynamic ranges are much lower leading to lower quantization noise when performing group quantization.

### Training of Scale Matrices

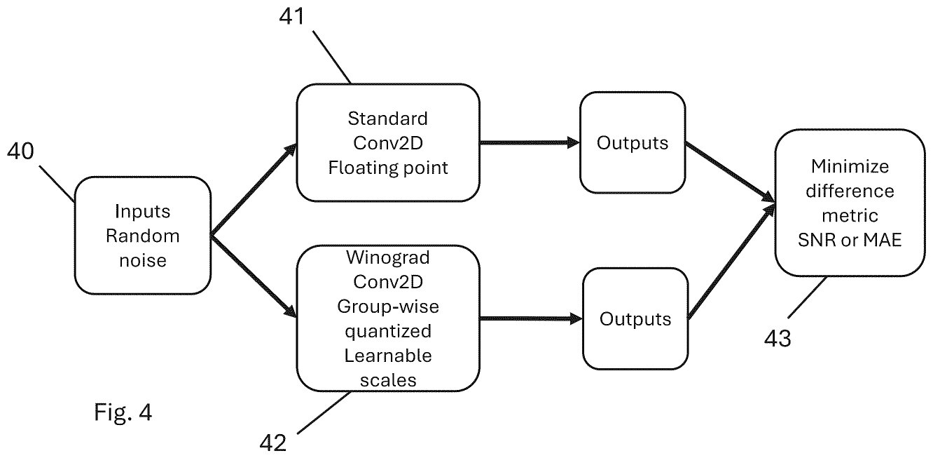

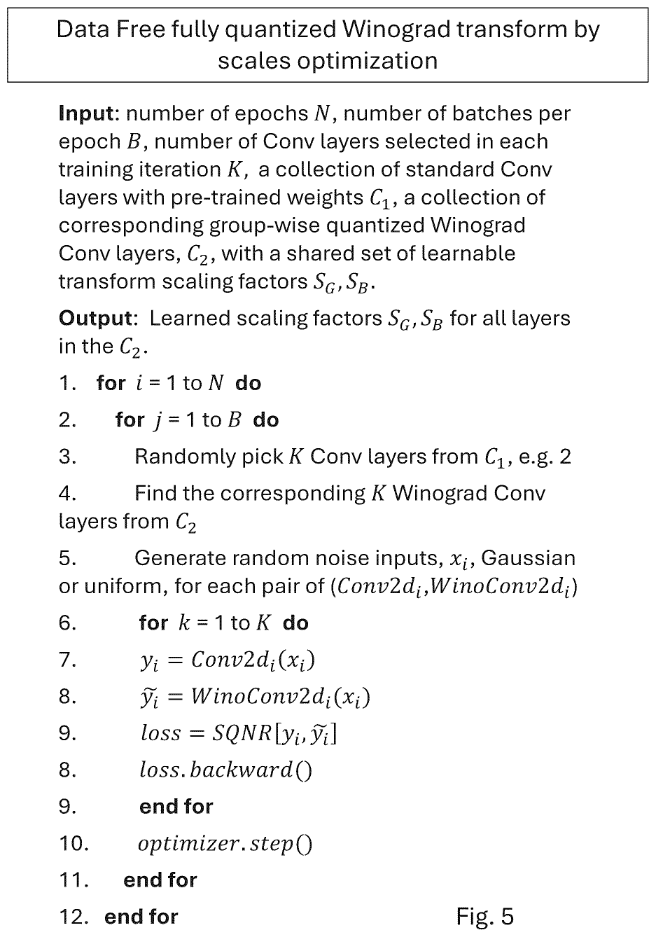

FIGS. 4 and 5 illustrate data-free training of scale matrices in connection with a neural network, such as a diffusion model. In particular, the scale matrices are trained using Gaussian or uniform noise rather than using any particular input data, such as sample data. As can be seen from FIG. 4, the training of the scale matrices may take random noise as input at step 40. The same random noise is input to both the neural network when computed with higher accuracy (step 41), such as when calculated using floating point values, and into the same network when group-wise quantized using a Winograd transformation as described above (Step 42). Inference performed on the input random noise generates neural network output for each of the higher accuracy implementation of the neural network (step 41) and the quantized Winograd implementation of the neural network (step 42). In a step 43, the outputs are compared and the learned scales of the scale matrices are adjusted using an optimization algorithm (e.g. back propagation) in order to minimize a difference metric. In some implementations, the difference metric may be a signal-to-noise ratio (ratio of mean squares) or a mean absolute error, which is a mean of the differences between the two outputs.

FIG. 5 shows the method in more detail. The method is performed across a number of epochs, N, and for a number of batches per epoch, B, (steps 1 and 2 in FIG. 5). In step 3, K convolution layers from the unquantized neural network are selected. In step 4, the K corresponding layers from the quantized Winograd neural network are selected.

In step 5, random noise inputs, xi, are generated for each selected pair of layers (one from the unquantized neural network and a corresponding layer from the quantized neural network). The noise may be Gaussian noise, uniform noise or some other type of noise.

In steps 6 to 8, for each of the K pairs of layers, inference is performed using the generated random noise as input to the respective layer.

In step 9, a loss is determined using a loss function. The loss may be a signal to noise ratio (SQNR) based on an output of the unquantized neural network (the signal) and a corresponding layer from the quantized neural network (the noisy signal) as indicated in FIG. 5.

In step 10, the loss is input into an optimizer to adjust the values of the scale matrices being trained. Examples of optimizer functions are Stochastic Gradient Descent (SGD) and Adam, but other optimizers may be used.

The method described above works well for some neural network models, such as image classification models and image generation models. Training with random noise as a data-free approach has been described, but another implementation may use some in-distribution calibration data for training. In such cases, the following approach may be implemented.

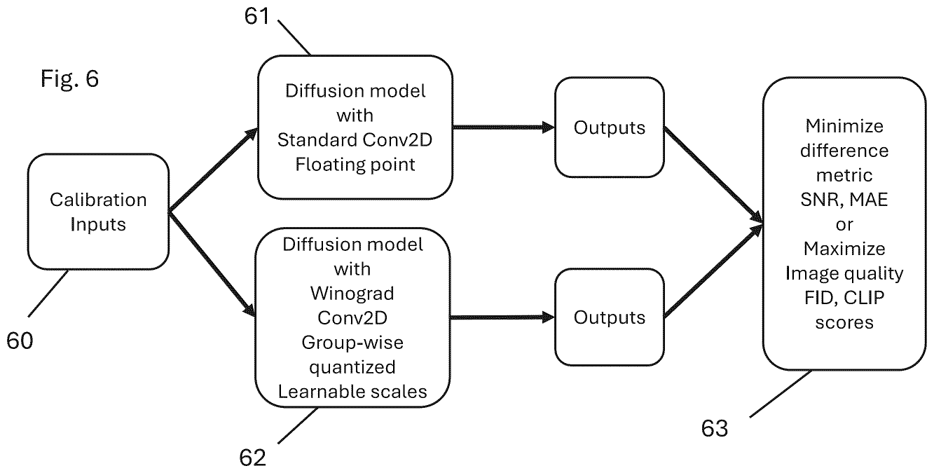

In another approach, the scale matrices may be trained using calibration data, such as image data for a neural network that receives image data during inference or text prompts for a model that performs text to image generation. FIG. 6 is a schematic diagram showing such a training process. In FIG. 6, the training of the scale matrices may take calibration inputs as input at step 60. The same calibration inputs are input to both the neural network when computed with higher accuracy (step 61), such as when calculated using floating point values, and into the same network when group-wise quantized using a Winograd transformation as described above (Step 62). Inference using the calibration inputs generates a neural network output for each of the higher accuracy implementation of the neural network (step 61) and the quantized Winograd implementation of the neural network (step 62). In a step 63, the outputs are compared and the learned scales of the scale matrices are adjusted using an optimization algorithm (back propagation etc.) in order to minimize a difference metric or maximize an image quality metric. In some examples, the difference metric may be a signal-to-noise ratio (ratio of mean squares) or a mean absolute error, which is a mean of the differences between the two outputs. In other implementations, an image quality metric may be used such as a Fréchet inception distance. In other implementations, the image quality metric may be a score generated by a Contrastive Language-Image Pre-training (CLIP) model for assessing image quality. Other approaches are possible.

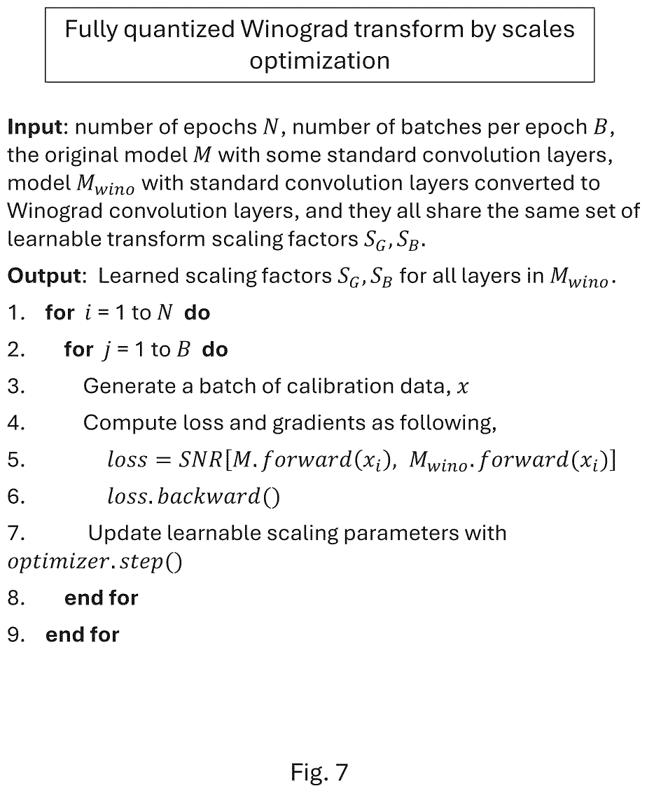

FIG. 7 shows the method of FIG. 6 in more detail. The method is performed across a number of epochs, N, and a number of batches per epoch, B, (steps 1 and 2). In step 3, a batch of calibration data, x, is generated. The calibration data is input to an input layer of the neural network when computed with higher accuracy (step 61), such as when calculated using floating point values, and into the same network when group-wise quantized using a Winograd transformation as described above (Step 62).

In steps 4 and 5, a loss is determined. The loss may be a signal to noise ratio (SQNR) based on an output of the unquantized neural network and from the quantized neural network as indicated in FIG. 6. As described above, other loss functions, including use of image quality metrics, are also possible.

In step 7, the loss is input into an optimizer to adjust the values of the scale matrices being trained. Examples of optimizer functions are Stochastic Gradient Descent and Adam.

The steps are repeated as indicated to learn the values of the scale matrices.

The methods of learning the scale matrices S_{A}, S_{B} and S_{G} described above can be performed in advance for a particular neural network model i.e. prior to inference. This is because the weights for the model are known. The scale matrices have been found not to need retraining for use with the particular input data. On the other hand, if a different neural network model is to be used (i.e. different weight values are used), it may be appropriate to retrain the scale matrices. Further, as mentioned previously, the techniques described above are suitable for post-training quantization and do not require retraining of the neural network model itself. The training derives the appropriate values for the scale matrices used for the Winograd transformation and accordingly do not require access to the original training data used to generate the neural network model.

Data-free training of scale matrices using random noise tends to make Winograd transformation matrices for a network transferable across datasets. Accordingly, in some implementations, scale matrices trained for a network may be used for any input dataset during inference.

The group-wise quantization method applied may be the same across all layers of a neural network. Accordingly, only a single set of scale matrices may need to be trained. In other implementations, a plurality of Winograd transformations may be used to quantize different parts of a neural network. For example, separate scale matrices could be provided for each layer of the neural network or for blocks of the neural network. In this case, the scale matrices for each of the Winograd transformations may be trained separately.

### Hardware and Inference

The methods described above may be performed by an information processing apparatus. The methods may be implemented using instructions that form one or more program that, when executed by one or more information processing apparatus, cause the information processing apparatus to perform the described method. In some cases, there may be provided a non-transitory computer-readable storage medium storing instructions that, when executed by an information processing apparatus, cause the information processing apparatus to perform a method described above.

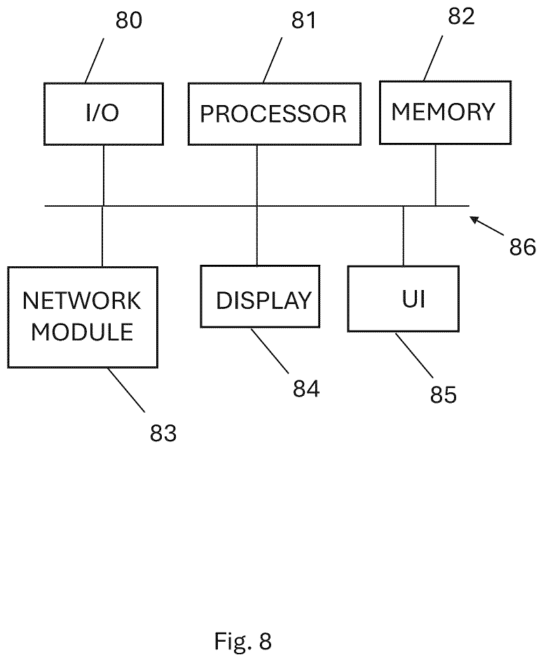

An example of an information processing apparatus will now be described with reference to FIG. 8. The information processing apparatus may be any type of information processing apparatus, such as a user device, server, or a cloud service.

FIG. 8 is a schematic diagram showing components of an example information processing apparatus suitable for use in the methods described above. The diagram is illustrative and different hardware configurations for information processing apparatus are possible as is well known in the art. The information processing apparatus includes an I/O interface 80, such a USB port, Thunderbolt port, etc. to which an additional device, such as a storage device, could be connected. The information processing apparatus comprises a processor 81, a storage in the form of memory 82, a network module 83, a display 84, and a user interface 85. The network module 83 may allow the information processing apparatus to communicate over a network such as a Wi-Fi network, a mobile telecommunications network, a local area network etc. The user interface may include components such as a keyboard, mouse, camera, etc. The components of the information processing apparatus may communicate with each other over a bus 86. Further components may be provided but are not shown or described. Any of the steps of the methods described above may be performed by computer-readable instructions of one or more programs stored in a storage and executed by a processor on one or more information processing apparatuses.

The processor 81 may be configured to perform a single-instruction multiple data (SIMID) instruction. A SIMD instruction is a supported operation of the processor that allows a single instruction received at the processor to cause the processor to process multiple data points at once. The multiple data points may be stored in a storage. The data points may be part of a table or other stored array of data. SIMD instructions are typically designed to utilize circuitry within the processor 81 that is more efficiently able to process multiple data elements than other operations of the processor that operate on data elements individually.

In a more specific example, an Arm® processor may support a UMMLA instruction, which is an instruction to perform an 8-bit integer matrix-multiply-accumulate operation. This instruction multiplies a 2×8 matrix of unsigned 8-bit integer values in a first source vector in a storage by an 8×2 matrix of unsigned 8-bit integer values in a second source vector in the storage. The result of the UMMLA instruction is a 2×2 32-bit integer matrix product.

Another example is VMMLA, which may perform a similar operation with 2×4 matrices of values.

To efficiently implement the above methods using SIMD instructions, the inner dimensions (the dimensions of the matrix that must match to allow matrix multiplication) of a multiplication being performed (such as the output transformation) should be at least as large as the width of the SIMD operation (in the example of UMMLA, 8. In other examples, the SIMID operation may have a different width. For example, the SIMD operation may take multiple rows or columns of data having a width of 16 or 32 bits. In some implementations, the dimensions of the matrix of intermediate values may be selected to be an exact multiple of the width of the data input to the SIMD operation. The SIMD operation may be a matrix multiplication operation.

In view of the above, the tile size and size of the Winograd transformation matrices (and hence scale matrices) may be selected considering the SIMD instruction width for integer processing of the processor that will perform inference using the neural network. As the training of the scales may take place in advance of inference by the processor 81, a neural network model may be optimized in advance for use on a particular hardware platform that includes the processor 81.

The above methods have described performing a group-wise quantized Winograd convolution on layers of a neural network model in order to improve processing performance. However, as explained above, for some processors, it may be desirable to select the tile size for Winograd transformation to be large enough to make use of SIMD instructions on the processor. Accordingly, in some implementations, for small layers of the network, no Winograd convolution is performed and the layer is executed using floating point operations.

The methods described above may comprise performing inference using the trained Winograd neural network including the learned scales. The inference process may run more quickly and consume less power because fewer operations are required due to the use of the Winograd transformation. Further, the performance loss of the network due to quantization should be reduced due to the learning of the scales for the Winograd transformation matrices.

As discussed above, in some implementations, the size of the tile for the Winograd transformations may be selected in accordance with the instruction set of a processor to be used to execute the inference of the neural network. The size of the transformation matrices may be selected to be at least the size of a width of a SIMID instruction of the processor (and, in some implementations, to be an exact multiple of the width of the SIMD instruction), the network may be able to be processed in a fast and power efficient manner.

As discussed above, in some implementations, the group size for the group-wise quantization may be selected in accordance with the instruction set of a processor to be used to execute the inference of the neural network. As the group size of the group-wise quantization may be selected to be at least the size of the width of a SIMD instruction of the processor (and, in some implementations, to be an exact multiple of the width of the SIMD instruction), the network may be able to be processed in a fast and power-efficient manner.

The methods described above have referred to large-scale diffusion models. However, the methods are generally applicable to neural network models. Accordingly, the methods may be applied, without limitation, to large-language models, large multimodal models, object detection models, image segmentation models, image classification models, other image generation models, neural networks built for scientific applications, etc.

### Further Embodiments

According to a first further embodiment there is provided a method, performed by an information processing apparatus, of generating data to be processed on a processing unit, the method comprising: obtaining a neural network; generating a Winograd neural network by applying a Winograd convolution to at least a portion of one or more layers of the neural network and quantizing at least one operation in the Winograd convolution, wherein the Winograd convolution can be expressed using a weight transformation matrix, a data transformation matrix, and an output transformation matrix, wherein the weight transformation matrix is a product of a weight scale matrix and a first Vandemonde matrix, the data transformation matrix is a product of a data scale matrix and a second Vandemonde matrix, and the output transformation matrix is a product of an output scale matrix and a third Vandemonde matrix; training the Winograd neural network with at least two of the weight scale matrix, the data scale matrix, and the output scale matrix as trainable parameters by comparing an output of the neural network and an output of the Winograd neural network, and adjusting the trainable parameters to generate a trained Winograd neural network; and generating, by the information processing apparatus, data to process the trained Winograd neural network on the processing unit.

Training the Winograd neural network may comprise: selecting a portion of the Winograd neural network for which a Winograd convolution is used; selecting a portion of the neural network corresponding to the selected portion of the Winograd neural network; inputting the same noise to the selected portion of the Winograd neural network to generate a Winograd output and to the selected portion of the neural network to generate a neural network output; comparing the Winograd output and the neural network output using a loss function; and adjusting the trainable parameters using an optimization method based on the comparison.

The noise may be one of Gaussian noise, random uniform noise, and a combination of at least two types of random noise distribution.

Training the Winograd neural network may comprise: processing first input data using the Winograd neural network to generate first output data; processing the first input data using the neural network to generate second output data; comparing the first output data and the second output data using a loss function; and adjusting the trainable parameters using an optimization method based on the comparison.

In some implementations, generating the Winograd neural network comprises generating the Winograd neural network such that an inner dimension of one or more multiplication to be performed in the Winograd convolution is selected to have a size that is at least the same size as a size of data that is processed by a single instruction, multiple data (SIMD) instruction of the processing unit.

In some implementations, generating the Winograd neural network comprises generating the Winograd neural network such that an inner dimension of a multiplication to be performed using the output transformation matrix is selected to have a size that is at least the same size as a size of data that is processed by a single instruction, multiple data (SIMD) instruction of the processing unit. In such implementations, the inner dimension of the multiplication may be performed using the output transformation matrix that is selected to have a size that is an exact multiple of the size of data that is processed by the single instruction, multiple data instruction.

The method may further comprise performing inference using the processing unit, wherein inference comprises using at least one single instruction, multiple data instruction to perform operations on multiple values using a single processor instruction.

The information processing apparatus may comprise the processing unit, or a second information processing apparatus that is different from the information processing apparatus comprises the processing unit.

Some methods may comprise performing inference using the processing unit. During inference the method may comprise steps of: obtaining transformed weight values that are a product of the weight transformation matrix of the trained Winograd neural network, the weights of the neural network, and a transpose of the weight transformation matrix of the trained Winograd neural network; obtaining transformed input data values that are a product of the transpose of the data transformation matrix of the trained Winograd neural network, input data values, and the data transformation matrix of the trained Winograd neural network; performing a Hadamard product of the transformed weight values and the transformed input data values to generate a matrix of intermediate values; and quantizing the intermediate values. Obtaining transformed weight values may comprise obtaining a set of transformed weight values that were generated prior to inference. At least one of the weights of the neural network and the input data values may be quantized. Quantizing the intermediate values may comprise performing a group-wise quantization of the intermediate values.

Inference may further comprise performing an output transformation by performing product of the transpose of the output transformation matrix of the trained Winograd neural network, the intermediate values, and the output transformation matrix of the trained Winograd neural network.

The group-wise quantization may be performed on groups that are formed of one of rows or columns of the matrix of intermediate values. Performing group-wise quantization may comprise generating a respective single scale factor and a plurality of integer values to represent a plurality of values in each group in a plurality of groups of intermediate values.

In some implementations, a group size of the groups may be selected to be at least the size of a width of a SIMD instruction of the processing unit. In some implementations, the group size may be selected to be an exact multiple of the width of the SIMD instruction.

In some implementations, the product of the weight scale matrix, the data scale matrix, and output scale matrix is constrained during training to be equal to an identity matrix.

Generating the Winograd neural network may comprise applying a first Winograd convolution a first portion of one or more layers of the neural network and applying a second Winograd convolution a second portion of one or more layers of the neural network, wherein the first Winograd convolution can be expressed as a first weight transformation matrix, a first data transformation matrix, and a first output transformation matrix, wherein the first weight transformation matrix is a product of a first weight scale matrix and a first Vandemonde matrix and the first data transformation matrix is a product of a first data scale matrix and a second Vandemonde matrix, and the first output transformation matrix is a product of a first output scale matrix and a third Vandemonde matrix, and the second Winograd convolution can be expressed as a second weight transformation matrix, a second data transformation matrix, and a second output transformation matrix, wherein the second weight transformation matrix is a product of a second weight scale matrix and a fourth Vandemonde matrix, the second data transformation matrix is a product of a second data scale matrix and a fifth Vandemonde matrix, and the second output transformation matrix is a product of a second output scale matrix and a sixth Vandemonde matrix; and training the Winograd neural network is performed with at least two of the first weight scale matrix, the first data scale matrix, and the first output scale matrix, and at least two of the second weight scale matrix, the second data scale matrix, and the second output scale matrix as trainable parameters.

Training the Winograd neural network may comprise generating an output of the neural network by performing floating-point calculations to process input data using the neural network.

Training the Winograd neural network may comprise training two of the weight scale matrix, the data scale matrix, and the output scale matrix as trainable parameters, and determining the other scale matrix based on the trainable parameters after training. The other scale matrix may be determined based on a constraint that a product of the weight scale matrix, the data scale matrix, and the output scale matrix is equal to the identity matrix.

Training the Winograd neural network may comprise training the Winograd neural network with the weight scale matrix and the data scale matrix as trainable parameters. The output scale matrix may be determined based on the weight scale matrix and the data scale matrix after training.

The neural network may be a text-to-image generation model. The neural network model may be a diffusion model.

A second further embodiment may provide non-transitory computer-readable storage medium comprising instructions that, when executed by an information processing apparatus, cause the information processing apparatus to perform a method of generating data to be processed on a processing unit, the method comprising: obtaining a neural network; generating a Winograd neural network by applying a Winograd convolution to at least a portion of one or more layers of the neural network and quantizing at least one operation in the Winograd convolution, wherein the Winograd convolution can be expressed using a weight transformation matrix, a data transformation matrix, and an output transformation matrix, wherein the weight transformation matrix is a product of a weight scale matrix and a first Vandemonde matrix, the data transformation matrix is a product of a data scale matrix and a second Vandemonde matrix, and the output transformation matrix is a product of an output scale matrix and a third Vandemonde matrix; training the Winograd neural network with at least two of the weight scale matrix, the data scale matrix, and the output scale matrix as trainable parameters by comparing an output of the neural network and an output of the Winograd neural network, and adjusting the trainable parameters to generate a trained Winograd neural network; and generating data to process the trained Winograd neural network on the processing unit.

A third further embodiment may provide an information processing apparatus comprising: a first processing unit; and a storage, wherein the storage stores instructions that, when executed by the information processing apparatus, causes the information processing apparatus to perform a method comprising: obtaining a neural network; generating a Winograd neural network by applying a Winograd convolution to at least a portion of one or more layers of the neural network and quantizing at least one operation in the Winograd convolution, wherein the Winograd convolution can be expressed using a weight transformation matrix, a data transformation matrix, and an output transformation matrix, wherein the weight transformation matrix is a product of a weight scale matrix and a first Vandemonde matrix, the data transformation matrix is a product of a data scale matrix and a second Vandemonde matrix, and the output transformation matrix is a product of an output scale matrix and a third Vandemonde matrix; training the Winograd neural network with at least two of the weight scale matrix, the data scale matrix, and the output scale matrix as trainable parameters by comparing an output of the neural network and an output of the Winograd neural network, and adjusting the trainable parameters to generate a trained Winograd neural network; and generating data to process the trained Winograd neural network on a second processing unit.

A fourth further embodiment may provide a method, performed by an information processing apparatus, of performing inference using a trained Winograd neural network, wherein during inference the method comprises steps of: obtaining transformed weight values that are a product of a weight transformation matrix of the trained Winograd neural network, weights of a neural network, and a transpose of the weight transformation matrix of the trained Winograd neural network; obtaining transformed input data values that are a product of a transpose of a data transformation matrix of the trained Winograd neural network, input data values, and the data transformation matrix of the trained Winograd neural network; performing a Hadamard product of the transformed weight values and the transformed input data values to generate a matrix of intermediate values; and quantizing the intermediate values; wherein the trained Winograd neural network has been obtained by: obtaining the neural network; generating the Winograd neural network by applying a Winograd convolution to at least a portion of one or more layers of the neural network and quantizing at least one operation in the Winograd convolution, wherein the Winograd convolution can be expressed using the weight transformation matrix, the data transformation matrix, and an output transformation matrix, wherein the weight transformation matrix is a product of a weight scale matrix and a first Vandemonde matrix, the data transformation matrix is a product of a data scale matrix and a second Vandemonde matrix, and the output transformation matrix is a product of an output scale matrix and a third Vandemonde matrix; and training the Winograd neural network with at least two of the weight scale matrix, the data scale matrix, and the output scale matrix as trainable parameters by comparing an output of the neural network and an output of the Winograd neural network, and adjusting the trainable parameters to generate a trained Winograd neural network.

A fifth further embodiment may provide non-transitory computer-readable storage medium comprising instructions that, when executed by an information processing apparatus, cause the information processing apparatus to perform a method of performing inference using a trained Winograd neural network, wherein during inference the method comprises steps of: obtaining transformed weight values that are a product of a weight transformation matrix of the trained Winograd neural network, weights of a neural network, and a transpose of the weight transformation matrix of the trained Winograd neural network; obtaining transformed input data values that are a product of a transpose of the data transformation matrix of the trained Winograd neural network, input data values, and the data transformation matrix of the trained Winograd neural network; performing a Hadamard product of the transformed weight values and the transformed input data values to generate a matrix of intermediate values; and quantizing the intermediate values; wherein the trained Winograd neural network has been obtained by: obtaining the neural network; generating the Winograd neural network by applying a Winograd convolution to at least a portion of one or more layers of the neural network and quantizing at least one operation in the Winograd convolution, wherein the Winograd convolution can be expressed using the weight transformation matrix, the data transformation matrix, and an output transformation matrix, wherein the weight transformation matrix is a product of a weight scale matrix and a first Vandemonde matrix, the data transformation matrix is a product of a data scale matrix and a second Vandemonde matrix, and the output transformation matrix is a product of an output scale matrix and a third Vandemonde matrix; and training the Winograd neural network with at least two of the weight scale matrix, the data scale matrix, and the output scale matrix as trainable parameters by comparing an output of the neural network and an output of the Winograd neural network, and adjusting the trainable parameters to generate a trained Winograd neural network. A sixth further embodiment may provide an information processing apparatus comprising: a first processing unit; and a storage, wherein the storage stores instructions that, when executed by the information processing apparatus, causes the information processing apparatus to perform a method of performing inference using a trained Winograd neural network, wherein during inference the method comprises steps of: obtaining transformed weight values that are a product of a weight transformation matrix of the trained Winograd neural network, weights of a neural network, and a transpose of the weight transformation matrix of the trained Winograd neural network; obtaining transformed input data values that are a product of a transpose of the data transformation matrix of the trained Winograd neural network, input data values, and the data transformation matrix of the trained Winograd neural network; performing a Hadamard product of the transformed weight values and the transformed input data values to generate a matrix of intermediate values; and quantizing the intermediate values; wherein the trained Winograd neural network has been obtained by: obtaining the neural network; generating the Winograd neural network by applying a Winograd convolution to at least a portion of one or more layers of the neural network and quantizing at least one operation in the Winograd convolution, wherein the Winograd convolution can be expressed using the weight transformation matrix, the data transformation matrix, and an output transformation matrix, wherein the weight transformation matrix is a product of a weight scale matrix and a first Vandemonde matrix, the data transformation matrix is a product of a data scale matrix and a second Vandemonde matrix, and the output transformation matrix is a product of an output scale matrix and a third Vandemonde matrix; and training the Winograd neural network with at least two of the weight scale matrix, the data scale matrix, and the output matrix as trainable parameters by comparing an output of the neural network and an output of the Winograd neural network, and adjusting the trainable parameters to generate a trained Winograd neural network.

What is claimed is:

1. A method, performed by an information processing apparatus, of generating data to be processed on a processing unit, the method comprising:
obtaining a neural network;
generating a Winograd neural network by applying a Winograd convolution to at least a portion of one or more layers of the neural network and quantizing at least one operation in the Winograd convolution, wherein the Winograd convolution can be expressed using a weight transformation matrix, a data transformation matrix, and an output transformation matrix, wherein the weight transformation matrix is a product of a weight scale matrix and a first Vandemonde matrix, the data transformation matrix is a product of a data scale matrix and a second Vandemonde matrix, and the output transformation matrix is a product of an output scale matrix and a third Vandemonde matrix;
training the Winograd neural network with at least two of the weight scale matrix, the data scale matrix, and the output scale matrix as trainable parameters by comparing an output of the neural network and an output of the Winograd neural network, and adjusting the trainable parameters to generate a trained Winograd neural network; and
generating, by the information processing apparatus, data to process the trained Winograd neural network on the processing unit.

2. A method according to claim 1, wherein training the Winograd neural network comprises:
selecting a portion of the Winograd neural network for which a Winograd convolution is used;
selecting a portion of the neural network corresponding to the selected portion of the Winograd neural network;
inputting the same noise to the selected portion of the Winograd neural network to generate a Winograd output and to the selected portion of the neural network to generate a neural network output;
comparing the Winograd output and the neural network output using a loss function; and
adjusting the trainable parameters using an optimization method based on the comparison.

3. A method according to claim 2, wherein the noise is one of Gaussian noise, random uniform noise, and a combination of at least two types of random noise distribution.

4. A method according to claim 1, wherein training the Winograd neural network comprises:
processing first input data using the Winograd neural network to generate first output data;
processing the first input data using the neural network to generate second output data;
comparing the first output data and the second output data using a loss function; and
adjusting the trainable parameters using an optimization method based on the comparison.

5. A method according to claim 1, wherein generating the Winograd neural network comprises generating the Winograd neural network such that an inner dimension of one or more multiplication to be performed in the Winograd convolution is selected to have a size that is at least the same size as a size of data that is processed by a single instruction, multiple data (SIMD) instruction of the processing unit.

6. A method according to claim 5, wherein the inner dimension of the multiplication to be performed using the output transformation matrix is selected to have a size that is an exact multiple of the size of data that is processed by the single instruction, multiple data instruction.

7. A method according to claim 5, further comprising performing inference using the processing unit, wherein inference comprises using at least one single instruction, multiple data instruction to perform operations on multiple values using a single processor instruction.

8. A method according to claim 1, wherein one of:
the information processing apparatus comprises the processing unit, or
a second information processing apparatus that is different from the information processing apparatus comprises the processing unit.

9. A method according to claim 1, further comprising performing inference using the processing unit, wherein during inference the method comprises steps of:
obtaining transformed weight values that are a product of the weight transformation matrix of the trained Winograd neural network, the weights of the neural network, and a transpose of the weight transformation matrix of the trained Winograd neural network;
obtaining transformed input data values that are a product of a transpose of the data transformation matrix of the trained Winograd neural network, input data values, and the data transformation matrix of the trained Winograd neural network;
performing a Hadamard product of the transformed weight values and the transformed input data values to generate a matrix of intermediate values; and
quantizing the intermediate values.

10. A method according to claim 9, wherein obtaining transformed weight values comprises obtaining a set of transformed weight values that were generated prior to inference.

11. A method according to claim 9, wherein at least one of the weights of the neural network and the input data values is quantized.

12. A method according to claim 9, wherein quantizing the intermediate values comprises performing a group-wise quantization of the intermediate values.

13. A method according to claim 12, wherein the group-wise quantization is performed on groups that are formed of one of rows or columns of the matrix of intermediate values.

14. A method according to claim 12, wherein performing group-wise quantization comprises generating a respective single scale factor and a plurality of integer values to represent a plurality of values in each group in a plurality of groups of intermediate values.

15. A method according to claim 1 wherein the product of the weight scale matrix, the data scale matrix, and output scale matrix is constrained during training to be equal to an identity matrix.

16. A method according to claim 1 wherein:
generating the Winograd neural network comprises applying a first Winograd convolution a first portion of one or more layers of the neural network and applying a second Winograd convolution a second portion of one or more layers of the neural network, wherein the first Winograd convolution can be expressed as a first weight transformation matrix, a first data transformation matrix, and a first output transformation matrix, wherein the first weight transformation matrix is a product of a first weight scale matrix and a first Vandemonde matrix, the first data transformation matrix is a product of a first data scale matrix and a second Vandemonde matrix, and the first output transformation matrix is a product of a first output scale matrix and a third Vandemonde matrix, and the second Winograd convolution can be expressed as a second weight transformation matrix, a second data transformation matrix, and a second output transformation matrix, wherein the second weight transformation matrix is a product of a second weight scale matrix and a fourth Vandemonde matrix, the second data transformation matrix is a product of a second data scale matrix and a fifth Vandemonde matrix, and the second output transformation matrix is a product of a second output scale matrix and a sixth Vandemonde matrix; and
training the Winograd neural network is performed with at least two of the first weight scale matrix, the first data scale matrix, and the first output scale matrix, and at least two of the second weight scale matrix, the second data scale matrix, and the second output scale matrix as trainable parameters.

17. A method according to claim 1, wherein training the Winograd neural network comprises generating an output of the neural network by performing floating-point calculations to process input data using the neural network.

18. A method according to claim 1, wherein training the Winograd neural network comprises training the Winograd neural network with the weight scale matrix and the data scale matrix as trainable parameters and the output scale matrix is determined based on the weight scale matrix and the data scale matrix after training.

19. An information processing apparatus comprising:
a first processing unit; and
a storage,
wherein the storage stores instructions that, when executed by the information processing apparatus, causes the information processing apparatus to perform a method comprising:
obtaining a neural network;
generating a Winograd neural network by applying a Winograd convolution to at least a portion of one or more layers of the neural network and quantizing at least one operation in the Winograd convolution, wherein the Winograd convolution can be expressed using a weight transformation matrix, a data transformation matrix, and an output transformation matrix, wherein the weight transformation matrix is a product of a weight scale matrix and a first Vandemonde matrix, the data transformation matrix is a product of a data scale matrix and a second Vandemonde matrix, and the output transformation matrix is a product of an output scale matrix and a third Vandemonde matrix;
training the Winograd neural network with at least two of the weight scale matrix, the data scale matrix, and the output scale matrix as trainable parameters by comparing an output of the neural network and an output of the Winograd neural network, and adjusting the trainable parameters to generate a trained Winograd neural network; and
generating data to process the trained Winograd neural network on a second processing unit.

20. A method, performed by an information processing apparatus, of performing inference using a trained Winograd neural network, wherein during inference the method comprises steps of:
obtaining transformed weight values that are a product of a weight transformation matrix of the trained Winograd neural network, weights of a neural network, and a transpose of the weight transformation matrix of the trained Winograd neural network;
obtaining transformed input data values that are a product of a data transformation matrix of the trained Winograd neural network, input data values, and a transpose of the data transformation matrix of the trained Winograd neural network;
performing a Hadamard product of the transformed weight values and the transformed input data values to generate a matrix of intermediate values; and
quantizing the intermediate values;
wherein the trained Winograd neural network has been obtained by:
obtaining the neural network;
generating the Winograd neural network by applying a Winograd convolution to at least a portion of one or more layers of the neural network and quantizing at least one operation in the Winograd convolution, wherein the Winograd convolution can be expressed using the weight transformation matrix, the data transformation matrix, and an output transformation matrix, wherein the weight transformation matrix is a product of a weight scale matrix and a first Vandemonde matrix, the data transformation matrix is a product of a data scale matrix and a second Vandemonde matrix, and the output transformation matrix is a product of an output scale matrix and a third Vandemonde matrix; and
training the Winograd neural network with at least two of the weight scale matrix, the data scale matrix, and the output scale matrix as trainable parameters by comparing an output of the neural network and an output of the Winograd neural network, and adjusting the trainable parameters to generate a trained Winograd neural network.
